(19) United States
(12) Patent Application Publication
(10) Pub. No.: US 2012/0227776 A1
(43) Pub. Date: Sep. 13, 2012

(54) Cloth Cushion Accessory For A Crutch

(76) Inventor: Blyth Neitzel, Apple Valley, CA (US)

(21) Appl. No.: 13/043,671

(22) Filed: Mar. 9, 2011

(51) Int. Cl. A61H 3/02; A44B 18/00

(52) U.S. Cl. 135/73

(57) ABSTRACT

A crutch under arm padding comprising: a padding for insertion on a underarm portion of a crutch; a slit opening in the padding for placement over the underarm portion; and an attachment means to attach the padding to the underarm portion. In one exemplary embodiment, the padding is configured as a toy dog and the attachment means includes a hook and loop fastener.

### BACKGROUND OF THE INVENTION

1. Field of Invention

The present invention relates to a padding device for a crutch that provides additional padding for the underarm support.

2. Description of Related Art

Crutches are devices used to assist in mobility for individuals that may be injured or impaired in their ability to walk. Crutches help the individual to keep their balance and to maneuver with the injured leg or joint associated with either leg. The crutches are usually used in pairs although some individuals may use one crutch due to ability to maintain balance. Crutches usually include a handgrip and a underarm pad that is placed against the ribcage beneath the armpits while holding the handgrip of that crutch. Many crutches include adjustable heights and a rubber stopper at the end thereof to secure the crutch in a stationary position when maneuvering around with the crutch.

Most crutches include padding on the underarm area to alleviate some of the discomfort that's associated with using crutches. A significant amount of weight is placed on the underarm portion of the crutch and therefore circulation may be cut off and pain or abrasion may occur after significant use of the crutch over a period of time. Specialized padding has been developed to address this area of concern as disclosed in U.S. Pat. No. 5,101,846 which discusses an improved crutch pad for providing extended cushioning for either side for the crutch and the crutch bar. U.S. Pat. No. 5,078,640 discusses a disposal plaything used for a crutch pad that includes inner compression filler. The pad of the '640 Patent provides a plaything in the form of a compressible three-dimensional article that is usable as a crutch pad to protect the underarm area of a user.

### SUMMARY OF THE INVENTION

The present invention relates to a crutch under arm padding comprising: a padding for insertion on a underarm portion of a crutch; a slit opening in the padding for placement over the underarm portion; and an attachment means to attach the padding to the underarm portion. In one exemplary embodiment, the padding is configured as a toy dog and the attachment means includes a hook and loop fastener.

### BRIEF DESCRIPTION OF DRAWINGS

FIG. 1 depicts the use of a crutch-padding accessory in accordance with the present invention.

### DETAILED DESCRIPTION

The present invention relates to a rubber crutch pad that provides additional cushioning and comfort for use with an underarm portion of a crutch. The present invention is designed in a configuration that depicts a toy dog with soft furry material on the exterior and batting or memory foam stuffed within the interior of the toy dog. An opening is provided on the underside of the toy dog to allow placement upon the crutch. The paws of the dog include a hook and loop fastener to hold the toy dog pad in place onto the underarm portion of the crutch.

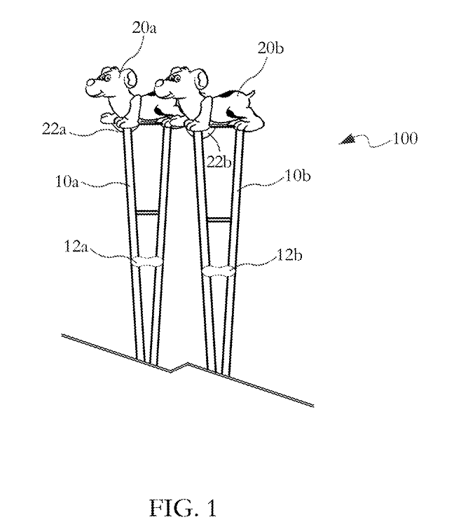

In reference to FIG. 1, a pair of crutch pads in accordance with the present invention is depicted. A Set of Crutches 100 is shown in FIG. 1 where Crutch Pads 20a, 20b are placed upon each Crutch 10a, 10b. Each Crutch 10a, 10b includes a Handgrip 12a, 12b and the Paddings 20a, 20b fit securely over the underarm portion of each respective crutch. The crutch pads are attached through the opening, not shown on the underside of each crutch pad. This opening is a slit-type opening that allows for the insertion of the pad over the underarm portion of the crutch. A Hook and Loop Fastener 22a, 22b are provided on each respective Crutch Pad 20a, 20b to secure the crutch pad onto each respective crutch.

The attachment means provided secures the crutch pads into place on each respective crutch. By securing the pads in this manner the user may freely using their crutches without the concern of losing the padding during use. Each crutch pad resembles a toy dog and includes a soft furry material on the exterior of the pad. Use of the pads as depicted in FIG. 1 helps to alleviate skin chafing and bruising that may occur in the armpit area of the user of the crutches. The stringing around the paws of each pad secures the pads in place and therefore helps to make the padding both decorative and functional. The instant invention has been shown and described in what it considers to be the most practical and preferred embodiments. It is recognized, however, that departures may be made there from within the scope of the invention and that obvious modifications will occur to a person skilled in the art.

What is claimed is:

1. A crutch under arm padding comprising:
a. a padding for insertion on a underarm portion of a crutch;
b. a slit opening in the padding for placement over the underarm portion; and
c. an attachment means to attach the padding to the underarm portion.

2. The crutch under arm padding according to claim 1, where the padding is configured as a toy dog.

3. The crutch under arm padding according to claim 1, where the attachment means includes a hook and loop fastener.
